(19) United States
(12) Patent Application Publication
(10) Pub. No.: US 2024/0118913 A1
(43) Pub. Date: Apr. 11, 2024

(54) APPARATUS AND METHOD TO IMPLEMENT SHARED VIRTUAL MEMORY IN A TRUSTED ZONE

(71) Applicant: Intel Corporation, Santa Clara, CA (US)

(72) Inventors: Kaijie GUO, Shanghai (CN); Junyuan WANG, Shanghai (CN); Maksim LUKOSHKOV, Clarecastle, Clare (IE); Weigang LI, Shanghai (CN); Xin ZENG, Shanghai (CN)

(21) Appl. No.: 18/283,205

(22) PCT Filed: Mar. 26, 2021
(86) PCT No.: PCT/CN2021/083178

§ 371 Date: Sep. 20, 2023

(51) Int. Cl. G06F 9/455

(52) U.S. Cl. CPC G06F 9/45558; G06F 2009/45579; G06F 2009/45583; G06F 2009/45591

(57) ABSTRACT

An apparatus and method to implement shared virtual memory in a trust zone. For example, one embodiment of a processor comprises: a plurality of cores; a memory controller coupled to the plurality of cores to establish a first private memory region in a system memory using a first key associated with a first trust domain of a first guest; an input/output memory management unit (IOMMU) coupled to the memory controller, the IOMMU to receive a memory access request by an input/output (IO) device, the memory access request comprising a first address space identifier and a guest virtual address (GVA), the IOMMU to access an entry in a first translation table using at least the first address space identifier to determine that the memory access request is directed to the first private memory region which is not directly accessible to the IOMMU, the IOMMU to generate an address translation request associated with the memory access request, wherein based on the address translation request, a virtual machine monitor (VMM) running on one or more of the plurality of cores is to initiate a secure transaction sequence with trust domain manager to cause a secure entry into the first trust domain to translate the GVA to a physical address based on the address space identifier, the IOMMU to receive the physical address from the VMM and to use the physical address to perform the requested memory access on behalf of the IO device.

### BACKGROUND

### Field of the Invention

The embodiments of the invention relate generally to the field of computer processors. More particularly, the embodiments relate to an apparatus and method to implement shared virtual memory (SVM) in a trusted zone.

### Description of the Related Art

Trust Domain Extensions (TDX) on x86 platforms provide new architectural elements to deploy isolated VMs called trust domains (TDs). Inside a TD, memory is grouped into two categories: private memory and shared memory. TDX works with multi-key total memory encryption (MKTME) engines to apply memory encryption for both private memory and shared memory using different keys.

For TD private memory, MKTME is provided with private key ID associates to TD private key for memory encryption to ensure all the private memory is only accessible from inside the TD. Address translation for the private memory must go through both the TD page table (which is in TD private memory) and the secure extended page table (SEPT). TD shared memory is used by the TD to exchange data (e.g. for DMA with PCI devices) with external entities and accessible by entities across the platform including PCIe devices.

However, the Shared Virtual Memory (SVM) feature of current IOMMUs cannot be used within the TD. This is because, for SVM functionality, the IOMMU needs to access the page table within the TD for Guest Virtual Address (GVA) to Guest Physical Address (GPA) translation. However, these page tables belong to private memory within the TD that is not accessible by the IOMMU. Therefore, even though the memory for direct memory access (DMA) uses shared memory, the IOMMU cannot perform the GVA to GPA translation as it does not have privilege to access first level page table in the TD.

### BRIEF DESCRIPTION OF THE DRAWINGS

A better understanding of the present invention can be obtained from the following detailed description in conjunction with the following drawings, in which:

FIG. 1 illustrates an example computer system architecture;

FIG. 2 illustrates a processor comprising a plurality of cores;

FIG. 3A illustrates a plurality of stages of a processing pipeline;

FIG. 3B illustrates details of one embodiment of a core;

FIG. 4 illustrates execution circuitry in accordance with one embodiment;

FIG. 5 illustrates one embodiment of a register architecture;

FIG. 6 illustrates one example of an instruction format;

FIG. 7 illustrates addressing techniques in accordance with one embodiment;

FIG. 8 illustrates one embodiment of an instruction prefix;

FIGS. 9A-D illustrate embodiments of how the R, X, and B fields of the prefix are used;

FIGS. 10A-B illustrate examples of a second instruction prefix;

FIG. 11 illustrates payload bytes of one embodiment of an instruction prefix;

FIG. 12 illustrates instruction conversion and binary translation implementations;

FIG. 13 illustrates one embodiment of a processor and computing architecture running trust domains;

FIG. 14 illustrates one embodiment including shared memory region and private memory region of a trust domain;

FIG. 15 illustrates an input/output memory management unit (IOMMU) which is unable to access a private memory region;

FIG. 16 illustrates one embodiment for securely providing access to a trust domain private memory by an IOMMU;

FIG. 17 illustrates one embodiment of a PASID context table with entries including a trust domain mode; and

FIG. 18 illustrates a transaction diagram in accordance with one embodiment of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Exemplary Computer Architectures

Detailed below are describes of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

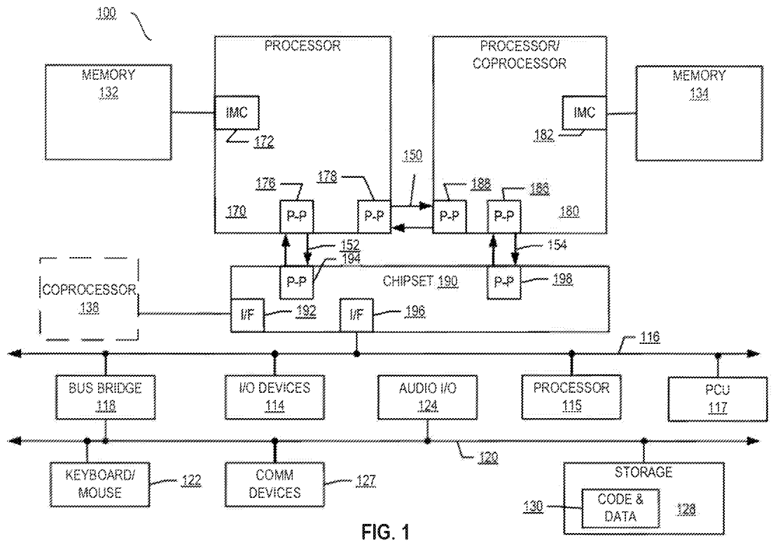

FIG. 1 illustrates embodiments of an exemplary system. Multiprocessor system 100 is a point-to-point interconnect system and includes a plurality of processors including a first processor 170 and a second processor 180 coupled via a point-to-point interconnect 150. In some embodiments, the first processor 170 and the second processor 180 are homogeneous. In some embodiments, first processor 170 and the second processor 180 are heterogenous.

Processors 170 and 180 are shown including integrated memory controller (IMC) units circuitry 172 and 182, respectively. Processor 170 also includes as part of its interconnect controller units point-to-point (P-P) interfaces 176 and 178; similarly, second processor 180 includes P-P interfaces 186 and 188. Processors 170, 180 may exchange information via the point-to-point (P-P) interconnect 150 using P-P interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a chipset 190 via individual P-P interconnects 152, 154 using point to point interface circuits 176, 194, 186, 198. Chipset 190 may optionally exchange information with a coprocessor 138 via a high-performance interface 192. In some embodiments, the coprocessor 138 is a special-purpose processor, such as, for example, a high-throughput MIC processor, a network or communication processor, compression engine, graphics processor, GPGPU, embedded processor, or the like.

A shared cache (not shown) may be included in either processor 170, 180 or outside of both processors, yet connected with the processors via P-P interconnect, such that either or both processors' local cache information may be stored in the shared cache if a processor is placed into a low power mode.

Chipset 190 may be coupled to a first interconnect 116 via an interface 196. In some embodiments, first interconnect 116 may be a Peripheral Component Interconnect (PCI) interconnect, or an interconnect such as a PCI Express interconnect or another I/O interconnect. In some embodiments, one of the interconnects couples to a power control unit (PCU) 117, which may include circuitry, software, and/or firmware to perform power management operations with regard to the processors 170, 180 and/or co-processor 138. PCU 117 provides control information to a voltage regulator to cause the voltage regulator to generate the appropriate regulated voltage. PCU 117 also provides control information to control the operating voltage generated. In various embodiments, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other embodiments, power management operations to be performed by PCU 117 may be implemented externally to a processor, such as by way of a separate power management integrated circuit (PMIC) or another component external to the processor. In yet other embodiments, power management operations to be performed by PCU 117 may be implemented within BIOS or other system software.

Various I/O devices 114 may be coupled to first interconnect 116, along with an interconnect (bus) bridge 118 which couples first interconnect 116 to a second interconnect 120. In some embodiments, one or more additional processor(s) 115, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 116. In some embodiments, second interconnect 120 may be a low pin count (LPC) interconnect. Various devices may be coupled to second interconnect 120 including, for example, a keyboard and/or mouse 122, communication devices 127 and a storage unit circuitry 128. Storage unit circuitry 128 may be a disk drive or other mass storage device which may include instructions/code and data 130, in some embodiments. Further, an audio I/O 124 may be coupled to second interconnect 120. Note that other architectures than the point-to-point architecture described above are possible. For example, instead of the point-to-point architecture, a system such as multiprocessor system 100 may implement a multi-drop interconnect or other such architecture.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

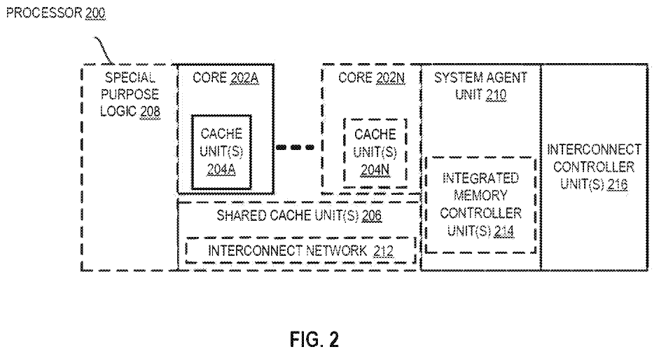

FIG. 2 illustrates a block diagram of embodiments of a processor 200 that may have more than one core, may have an integrated memory controller, and may have integrated graphics. The solid lined boxes illustrate a processor 200 with a single core 202A, a system agent 210, a set of one or more interconnect controller units circuitry 216, while the optional addition of the dashed lined boxes illustrates an alternative processor 200 with multiple cores 202(A)-(N), a set of one or more integrated memory controller unit(s) circuitry 214 in the system agent unit circuitry 210, and special purpose logic 208, as well as a set of one or more interconnect controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202(A)-(N) being one or more general purpose cores (e.g., general purpose in-order cores, general purpose out-of-order cores, or a combination of the two); 2) a coprocessor with the cores 202(A)-(N) being a large number of special purpose cores intended primarily for graphics and/or scientific (throughput); and 3) a coprocessor with the cores 202(A)-(N) being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

A memory hierarchy includes one or more levels of cache unit(s) circuitry 204(A)-(N) within the cores 202(A)-(N), a set of one or more shared cache units circuitry 206, and external memory (not shown) coupled to the set of integrated memory controller units circuitry 214. The set of one or more shared cache units circuitry 206 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 212 interconnects the special purpose logic 208 (e.g., integrated graphics logic), the set of shared cache units circuitry 206, and the system agent unit circuitry 210, alternative embodiments use any number of well-known techniques for interconnecting such units. In some embodiments, coherency is maintained between one or more of the shared cache units circuitry 206 and cores 202(A)-(N).

In some embodiments, one or more of the cores 202(A)-(N) are capable of multi-threading. The system agent unit circuitry 210 includes those components coordinating and operating cores 202(A)-(N). The system agent unit circuitry 210 may include, for example, power control unit (PCU) circuitry and/or display unit circuitry (not shown). The PCU may be or may include logic and components needed for regulating the power state of the cores 202(A)-(N) and/or the special purpose logic 208 (e.g., integrated graphics logic). The display unit circuitry is for driving one or more externally connected displays.

The cores 202(A)-(N) may be homogenous or heterogeneous in terms of architecture instruction set; that is, two or more of the cores 202(A)-(N) may be capable of executing the same instruction set, while other cores may be capable of executing only a subset of that instruction set or a different instruction set.

Exemplary Core Architectures

In-Order and Out-of-Order Core Block Diagram

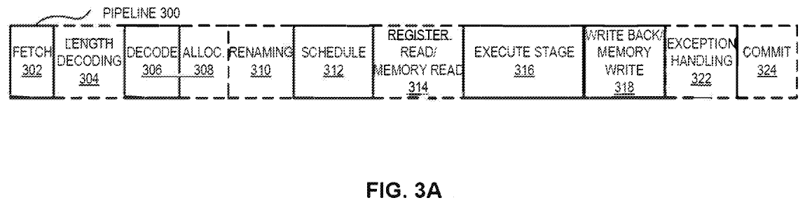

FIG. 3(A) is a block diagram illustrating both an exemplary in-order pipeline and an exemplary register renaming, out-of-order issue/execution pipeline according to embodiments of the invention. FIG. 3(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 3(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 3(A), a processor pipeline 300 includes a fetch stage 302, an optional length decode stage 304, a decode stage 306, an optional allocation stage 308, an optional renaming stage 310, a scheduling (also known as a dispatch or issue) stage 312, an optional register read/memory read stage 314, an execute stage 316, a write back/memory write stage 318, an optional exception handling stage 322, and an optional commit stage 324. One or more operations can be performed in each of these processor pipeline stages. For example, during the fetch stage 302, one or more instructions are fetched from instruction memory, during the decode stage 306, the one or more fetched instructions may be decoded, addresses (e.g., load store unit (LSU) addresses) using forwarded register ports may be generated, and branch forwarding (e.g., immediate offset or an link register (LR)) may be performed. In one embodiment, the decode stage 306 and the register read/memory read stage 314 may be combined into one pipeline stage. In one embodiment, during the execute stage 316, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 300 as follows: 1) the instruction fetch 338 performs the fetch and length decoding stages 302 and 304; 2) the decode unit circuitry 340 performs the decode stage 306; 3) the rename/allocator unit circuitry 352 performs the allocation stage 308 and renaming stage 310; 4) the scheduler unit(s) circuitry 356 performs the schedule stage 312; 5) the physical register file(s) unit(s) circuitry 358 and the memory unit circuitry 370 perform the register read/memory read stage 314; the execution cluster 360 perform the execute stage 316; 6) the memory unit circuitry 370 and the physical register file(s) unit(s) circuitry 358 perform the write back/memory write stage 318; 7) various units (unit circuitry) may be involved in the exception handling stage 322; and 8) the retirement unit circuitry 354 and the physical register file(s) unit(s) circuitry 358 perform the commit stage 324.

FIG. 3(B) shows processor core 390 including front-end unit circuitry 330 coupled to an execution engine unit circuitry 350, and both are coupled to a memory unit circuitry 370. The core 390 may be a reduced instruction set computing (RISC) core, a complex instruction set computing (CISC) core, a very long instruction word (VLIW) core, or a hybrid or alternative core type. As yet another option, the core 390 may be a special-purpose core, such as, for example, a network or communication core, compression engine, coprocessor core, general purpose computing graphics processing unit (GPGPU) core, graphics core, or the like.

The front end unit circuitry 330 may include branch prediction unit circuitry 332 coupled to an instruction cache unit circuitry 334, which is coupled to an instruction translation lookaside buffer (TLB) 336, which is coupled to instruction fetch unit circuitry 338, which is coupled to decode unit circuitry 340. In one embodiment, the instruction cache unit circuitry 334 is included in the memory unit circuitry 370 rather than the front-end unit circuitry 330. The decode unit circuitry 340 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 340 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 390 includes a microcode ROM (not shown) or other medium that stores microcode for certain macroinstructions (e.g., in decode unit circuitry 340 or otherwise within the front end unit circuitry 330). In one embodiment, the decode unit circuitry 340 includes a micro-operation (micro-op) or operation cache (not shown) to hold/cache decoded operations, micro-tags, or micro-operations generated during the decode or other stages of the processor pipeline 300. The decode unit circuitry 340 may be coupled to rename/allocator unit circuitry 352 in the execution engine unit circuitry 350.

The execution engine circuitry 350 includes the rename/allocator unit circuitry 352 coupled to a retirement unit circuitry 354 and a set of one or more scheduler(s) circuitry 356. The scheduler(s) circuitry 356 represents any number of different schedulers, including reservations stations, central instruction window, etc. In some embodiments, the scheduler(s) circuitry 356 can include arithmetic logic unit (ALU) scheduler/scheduling circuitry, ALU queues, arithmetic generation unit (AGU) scheduler/scheduling circuitry, AGU queues, etc. The scheduler(s) circuitry 356 is coupled to the physical register file(s) circuitry 358. Each of the physical register file(s) circuitry 358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 358 includes vector registers unit circuitry, writemask registers unit circuitry, and scalar register unit circuitry. These register units may provide architectural vector registers, vector mask registers, general-purpose registers, etc. The physical register file(s) unit(s) circuitry 358 is overlapped by the retirement unit circuitry 354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 354 and the physical register file(s) circuitry 358 are coupled to the execution cluster(s) 360. The execution cluster(s) 360 includes a set of one or more execution units circuitry 362 and a set of one or more memory access circuitry 364. The execution units circuitry 362 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 356, physical register file(s) unit(s) circuitry 358, and execution cluster(s) 360 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 364). It should also be understood that where separate pipelines are used, one or more of these pipelines may be out-of-order issue/execution and the rest in-order.

In some embodiments, the execution engine unit circuitry 350 may perform load store unit (LSU) address/data pipelining to an Advanced Microcontroller Bus (AHB) interface (not shown), and address phase and writeback, data phase load, store, and branches.

The set of memory access circuitry 364 is coupled to the memory unit circuitry 370, which includes data TLB unit circuitry 372 coupled to a data cache circuitry 374 coupled to a level 2 (L2) cache circuitry 376. In one exemplary embodiment, the memory access units circuitry 364 may include a load unit circuitry, a store address unit circuit, and a store data unit circuitry, each of which is coupled to the data TLB circuitry 372 in the memory unit circuitry 370. The instruction cache circuitry 334 is further coupled to a level 2 (L2) cache unit circuitry 376 in the memory unit circuitry 370. In one embodiment, the instruction cache 334 and the data cache 374 are combined into a single instruction and data cache (not shown) in L2 cache unit circuitry 376, a level 3 (L3) cache unit circuitry (not shown), and/or main memory. The L2 cache unit circuitry 376 is coupled to one or more other levels of cache and eventually to a main memory.

The core 390 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 390 includes logic to support a packed data instruction set extension (e.g., AVX1, AVX2), thereby allowing the operations used by many multimedia applications to be performed using packed data.

Exemplary Execution Unit(s) Circuitry

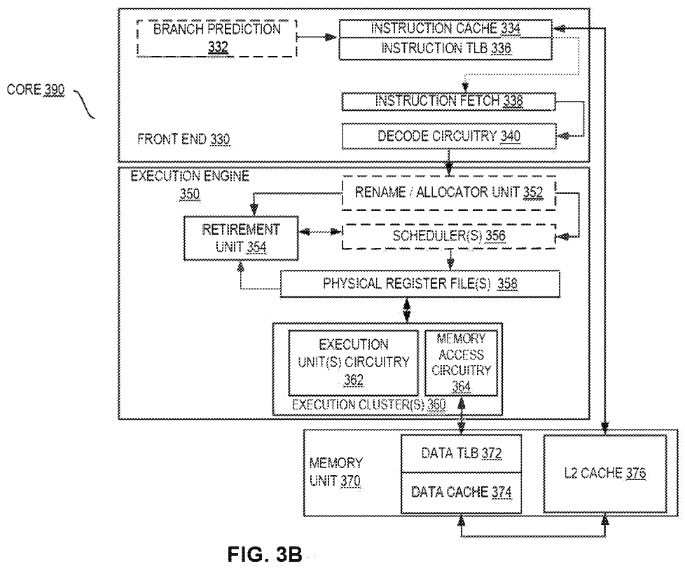

FIG. 4 illustrates embodiments of execution unit(s) circuitry, such as execution unit(s) circuitry 362 of FIG. 3(B). As illustrated, execution unit(s) circuitry 362 may include one or more ALU circuits 401, vector/SIMD unit circuits 403, load/store unit circuits 405, and/or branch/jump unit circuits 407. ALU circuits 401 perform integer arithmetic and/or Boolean operations. Vector/SIMD unit circuits 403 perform vector/SIMD operations on packed data (such as SIMD/vector registers). Load/store unit circuits 405 execute load and store instructions to load data from memory into registers or store from registers to memory. Load/store unit circuits 405 may also generate addresses. Branch/jump unit circuits 407 cause a branch or jump to a memory address depending on the instruction. Floating-point unit (FPU) circuits 409 perform floating-point arithmetic. The width of the execution unit(s) circuitry 362 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

Exemplary Register Architecture

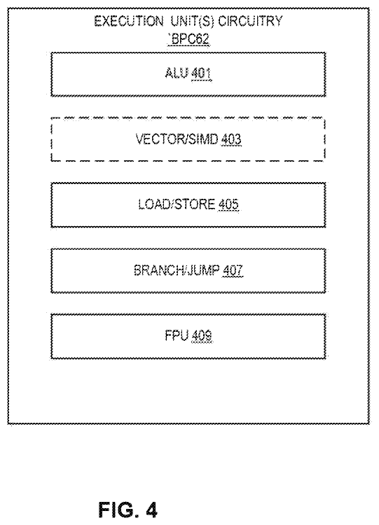

FIG. 5 is a block diagram of a register architecture 500 according to some embodiments. As illustrated, there are vector/SIMD registers 510 that vary from 128-bit to 1,024 bits width. In some embodiments, the vector/SIMD registers 510 are physically 512-bits and, depending upon the mapping, only some of the lower bits are used. For example, in some embodiments, the vector/SIMD registers 510 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 500 includes writemask/predicate registers 515. For example, in some embodiments, there are 8 writemask/predicate registers (sometimes called k0 through k7) that are each 16-bit, 32-bit, 64-bit, or 128-bit in size. Writemask/predicate registers 515 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 515 corresponds to a data element position of the destination. In other embodiments, the writemask/predicate registers 515 are scalable and consists of a set number of enable bits for a given vector element (e.g., 8 enable bits per 64-bit vector element).

The register architecture 500 includes a plurality of general-purpose registers 525. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 500 includes scalar floating-point register 545 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 540 (e.g., EFLAGS, RFLAGS, etc.) store status and control information for arithmetic, compare, and system operations. For example, the one or more flag registers 540 may store condition code information such as carry, parity, auxiliary carry, zero, sign, and overflow. In some embodiments, the one or more flag registers 540 are called program status and control registers.

Segment registers 520 contain segment points for use in accessing memory. In some embodiments, these registers are referenced by the names CS, DS, SS, ES, FS, and GS.

Machine specific registers (MSRs) 535 control and report on processor performance. Most MSRs 535 handle system-related functions and are not accessible to an application program. Machine check registers 560 consist of control, status, and error reporting MSRs that are used to detect and report on hardware errors.

One or more instruction pointer register(s) 530 store an instruction pointer value. Control register(s) 555 (e.g., CR0-CR4) determine the operating mode of a processor (e.g., processor 170, 180, 138, 115, and/or 200) and the characteristics of a currently executing task. Debug registers 550 control and allow for the monitoring of a processor or core's debugging operations.

Memory management registers 565 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

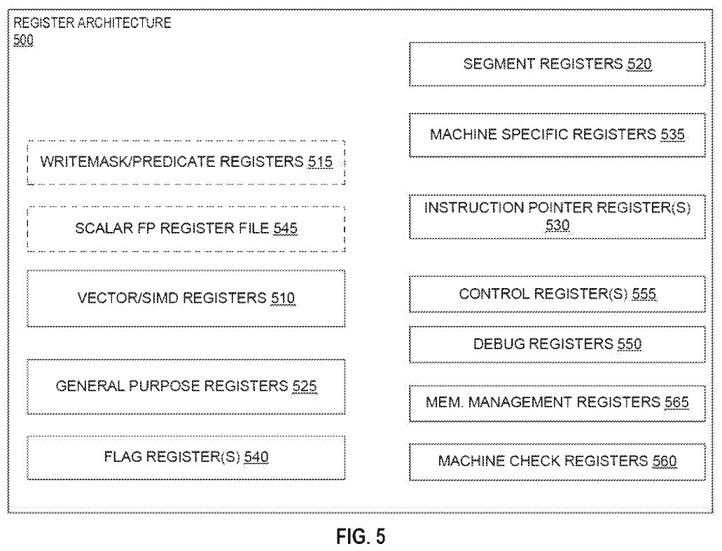

FIG. 6 illustrates embodiments of an instruction format. As illustrated, an instruction may include multiple components including, but not limited to, one or more fields for: one or more prefixes 601, an opcode 603, addressing information 605 (e.g., register identifiers, memory addressing information, etc.), a displacement value 607, and/or an immediate 609. Note that some instructions utilize some or all of the fields of the format whereas others may only use the field for the opcode 603. In some embodiments, the order illustrated is the order in which these fields are to be encoded, however, it should be appreciated that in other embodiments these fields may be encoded in a different order, combined, etc.

The prefix(es) field(s) 601, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0)(26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 603 is used to at least partially define the operation to be performed upon a decoding of the instruction. In some embodiments, a primary opcode encoded in the opcode field 603 is 1, 2, or 3 bytes in length. In other embodiments, a primary opcode can be a different length. An additional 3-bit opcode field is sometimes encoded in another field.

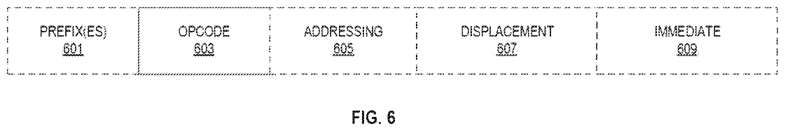

The addressing field 605 is used to address one or more operands of the instruction, such as a location in memory or one or more registers. FIG. 7 illustrates embodiments of the addressing field 605. In this illustration, an optional ModR/M byte 702 and an optional Scale, Index, Base (SIB) byte 704 are shown. The ModR/M byte 702 and the SIB byte 704 are used to encode up to two operands of an instruction, each of which is a direct register or effective memory address. Note that each of these fields are optional in that not all instructions include one or more of these fields. The MOD R/M byte 702 includes a MOD field 742, a register field 744, and R/M field 746.

The content of the MOD field 742 distinguishes between memory access and non-memory access modes. In some embodiments, when the MOD field 742 has a value of b11, a register-direct addressing mode is utilized, and otherwise register-indirect addressing is used.

The register field 744 may encode either the destination register operand or a source register operand, or may encode an opcode extension and not be used to encode any instruction operand. The content of register index field 744, directly or through address generation, specifies the locations of a source or destination operand (either in a register or in memory). In some embodiments, the register field 744 is supplemented with an additional bit from a prefix (e.g., prefix 601) to allow for greater addressing.

The R/M field 746 may be used to encode an instruction operand that references a memory address, or may be used to encode either the destination register operand or a source register operand. Note the R/M field 746 may be combined with the MOD field 742 to dictate an addressing mode in some embodiments.

The SIB byte 704 includes a scale field 752, an index field 754, and a base field 756 to be used in the generation of an address. The scale field 752 indicates scaling factor. The index field 754 specifies an index register to use. In some embodiments, the index field 754 is supplemented with an additional bit from a prefix (e.g., prefix 601) to allow for greater addressing. The base field 756 specifies a base register to use. In some embodiments, the base field 756 is supplemented with an additional bit from a prefix (e.g., prefix 601) to allow for greater addressing. In practice, the content of the scale field 752 allows for the scaling of the content of the index field 754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 607 provides this value. Additionally, in some embodiments, a displacement factor usage is encoded in the MOD field of the addressing field 605 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 607.

In some embodiments, an immediate field 609 specifies an immediate for the instruction. An immediate may be encoded as a 1-byte value, a 2-byte value, a 4-byte value, etc.

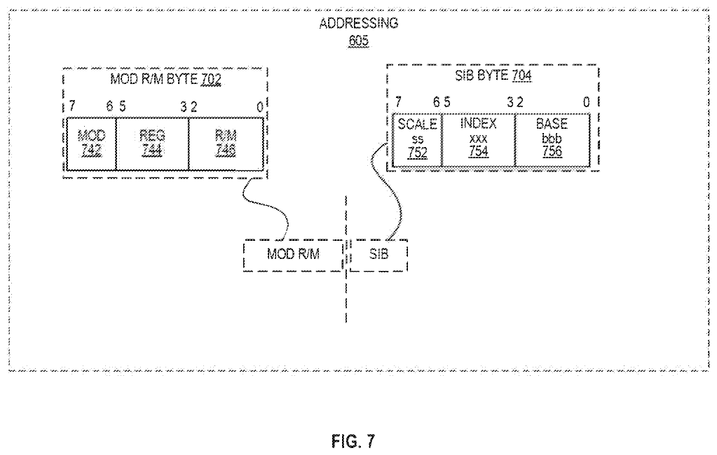

FIG. 8 illustrates embodiments of a first prefix 601(A). In some embodiments, the first prefix 601(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 601(A) may specify up to three registers using 3-bit fields depending on the format: 1) using the reg field 744 and the R/M field 746 of the Mod R/M byte 702; 2) using the Mod R/M byte 702 with the SIB byte 704 including using the reg field 744 and the base field 756 and index field 754; or 3) using the register field of an opcode.

In the first prefix 601(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 744 and MOD R/M R/M field 746 alone can each only address 8 registers.

In the first prefix 601(A), bit position 2 (R) may an extension of the MOD R/M reg field 744 and may be used to modify the ModR/M reg field 744 when that field encodes a general purpose register, a 64-bit packed data register (e.g., a SSE register), or a control or debug register. R is ignored when Mod R/M byte 702 specifies other registers or defines an extended opcode.

Bit position 1 (X) X bit may modify the SIB byte index field 754.

Bit position B (B) B may modify the base in the Mod R/M R/M field 746 or the SIB byte base field 756; or it may modify the opcode register field used for accessing general purpose registers (e.g., general purpose registers 525).

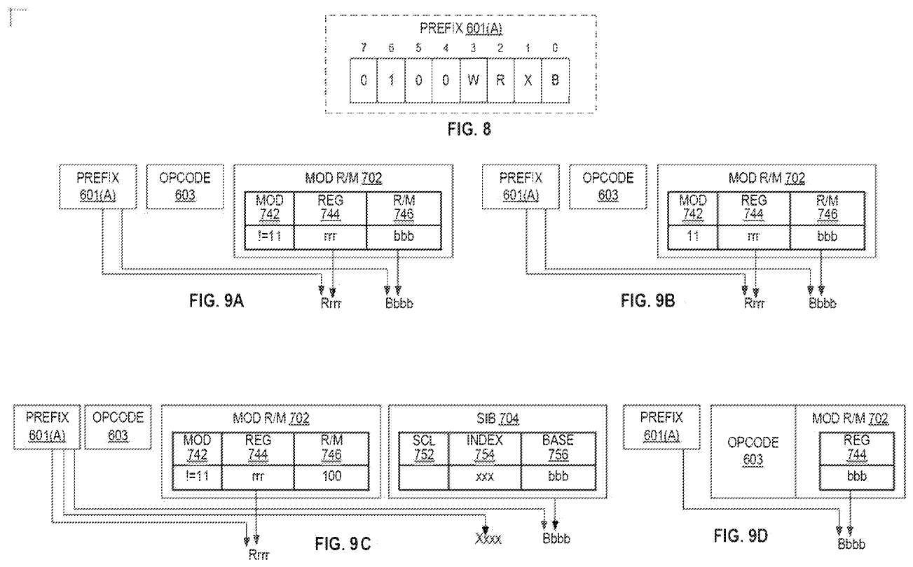

FIGS. 9(A)-(D) illustrate embodiments of how the R, X, and B fields of the first prefix 601(A) are used. FIG. 9(A) illustrates R and B from the first prefix 601(A) being used to extend the reg field 744 and R/M field 746 of the MOD R/M byte 702 when the SIB byte 7 04 is not used for memory addressing. FIG. 9(B) illustrates R and B from the first prefix 601(A) being used to extend the reg field 744 and R/M field 746 of the MOD R/M byte 702 when the SIB byte 7 04 is not used (register-register addressing). FIG. 9(C) illustrates R, X, and B from the first prefix 601(A) being used to extend the reg field 744 of the MOD R/M byte 702 and the index field 754 and base field 756 when the SIB byte 7 04 being used for memory addressing. FIG. 9(D) illustrates B from the first prefix 601(A) being used to extend the reg field 744 of the MOD R/M byte 702 when a register is encoded in the opcode 603.

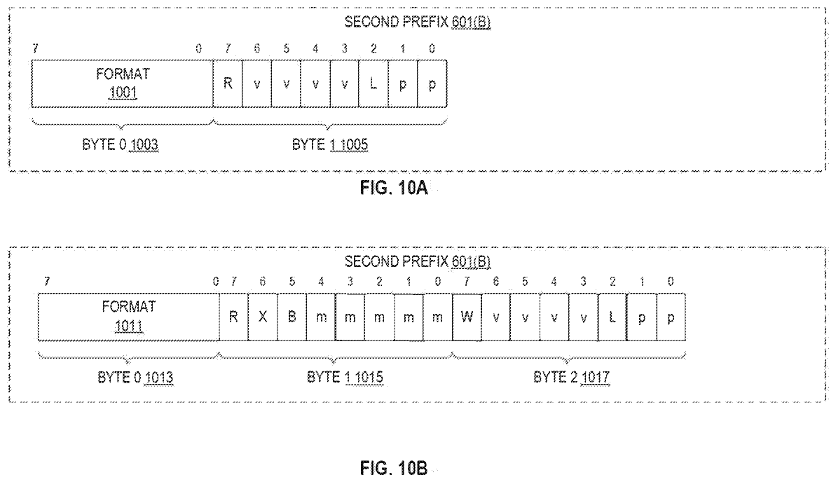

FIGS. 10(A)-(B) illustrate embodiments of a second prefix 601(B). In some embodiments, the second prefix 601(B) is an embodiment of a VEX prefix. The second prefix 601(B) encoding allows instructions to have more than two operands, and allows SIMD vector registers (e.g., vector/SIMD registers 510) to be longer than 64-bits (e.g., 128-bit and 256-bit). The use of the second prefix 601(B) provides for three-operand (or more) syntax. For example, previous two-operand instructions performed operations such as A=A+B, which overwrites a source operand. The use of the second prefix 601(B) enables operands to perform nondestructive operations such as A=B+C.

In some embodiments, the second prefix 601(B) comes in two forms—a two-byte form and a three-byte form. The two-byte second prefix 601(B) is used mainly for 128-bit, scalar, and some 256-bit instructions; while the three-byte second prefix 601(B) provides a compact replacement of the first prefix 601(A) and 3-byte opcode instructions.

FIG. 10(A) illustrates embodiments of a two-byte form of the second prefix 601(B). In one example, a format field 1001 (byte 0 1003) contains the value C5H. In one example, byte 1 1005 includes a “R” value in bit[7]. This value is the complement of the same value of the first prefix 601(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746 and the Mod R/M reg field 744 encode three of the four operands. Bits[7:4] of the immediate 609 are then used to encode the third source register operand.

FIG. 10(B) illustrates embodiments of a three-byte form of the second prefix 601(B). in one example, a format field 1011 (byte 0 1013) contains the value C4H. Byte 1 1015 includes in bits[7:5] “R,” “X,” and “B” which are the complements of the same values of the first prefix 601(A). Bits[4:0] of byte 1 1015 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit[7] of byte 2 1017 is used similar to W of the first prefix 601(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746, and the Mod R/M reg field 744 encode three of the four operands. Bits[7:4] of the immediate 609 are then used to encode the third source register operand.

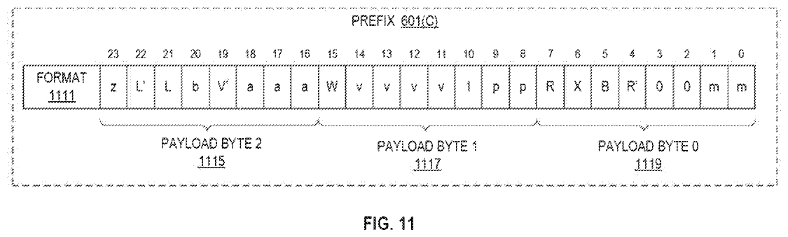

FIG. 11 illustrates embodiments of a third prefix 601(C). In some embodiments, the first prefix 601(A) is an embodiment of an EVEX prefix. The third prefix 601(C) is a four-byte prefix.

The third prefix 601(C) can encode 32 vector registers (e.g., 128-bit, 256-bit, and 512-bit registers) in 64-bit mode. In some embodiments, instructions that utilize a writemask/opmask (see discussion of registers in a previous figure, such as FIG. 5) or predication utilize this prefix. Opmask register allow for conditional processing or selection control. Opmask instructions, whose source/destination operands are opmask registers and treat the content of an opmask register as a single value, are encoded using the second prefix 601(B).

The third prefix 601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 601(C) is a format field 1111 that has a value, in one example, of 62H. Subsequent bytes are referred to as payload bytes 1115-1119 and collectively form a 24-bit value of P[23:0] providing specific capability in the form of one or more fields (detailed herein).

In some embodiments, P[1:0] of payload byte 1119 are identical to the low two mmmmm bits. P[3:2] are reserved in some embodiments. Bit P[4] (R′) allows access to the high 16 vector register set when combined with P[7] and the ModR/M reg field 744. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 744 and ModR/M R/M field 746. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 601(A) and second prefix 611(B) and may serve as an opcode extension bit or operand size promotion.

P[18:16] specify the index of a register in the opmask (writemask) registers (e.g., writemask/predicate registers 515). In one embodiment of the invention, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary embodiments of encoding of registers in instructions using the third prefix 601(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or Destination |
| RM | X | B | ModR/M | GPR, Vector | 1st Source or Destination |
| | | | R/M | | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

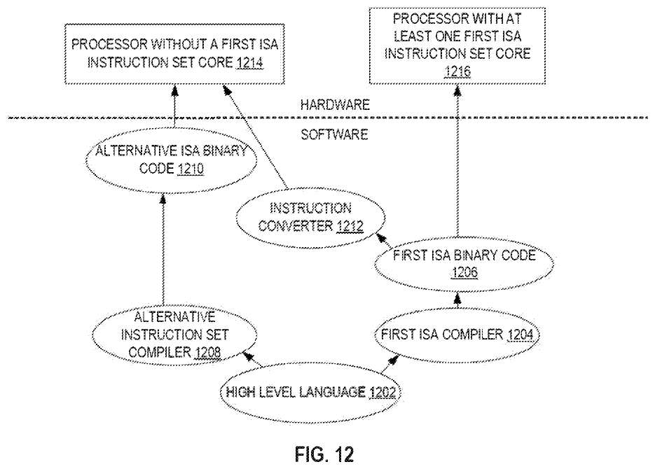

FIG. 12 illustrates a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 12 shows a program in a high level language 1202 may be compiled using a first ISA compiler 1204 to generate first ISA binary code 1206 that may be natively executed by a processor with at least one first instruction set core 1216. The processor with at least one first ISA instruction set core 1216 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 1204 represents a compiler that is operable to generate first ISA binary code 1206 (e.g., object code) that can, with or without additional linkage processing, be executed on the processor with at least one first ISA instruction set core 1216.

Similarly, FIG. 12 shows the program in the high level language 1202 may be compiled using an alternative instruction set compiler 1208 to generate alternative instruction set binary code 1210 that may be natively executed by a processor without a first ISA instruction set core 1214. The instruction converter 1212 is used to convert the first ISA binary code 1206 into code that may be natively executed by the processor without a first ISA instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have a first ISA instruction set processor or core to execute the first ISA binary code 1206.

### Apparatus and Method to Implement

### Shared Virtual Memory in a Trusted Zone

A. Overview of a Trust Domain Architecture

Aspects of the present disclosure relate to trust domains (TDs)—secure software execution environments for workloads, which may include operating systems (OSs) and applications running on top of the OSs. The workloads may also include one or more virtual machines (VMs) running under the control of a virtual machine monitor (VMM), along with other OSs/applications executed inside of the VMs.

It is especially important for data within a TD to be protected from access by unauthorized persons and malicious software. Unencrypted plaintext data residing in memory, as well as data moving between the memory and a processor, may be vulnerable to a variety of attacks (e.g., bus scanning, memory scanning, etc.) used by hackers to retrieve data from memory. In some instances, data may include keys or other information used to encrypt sensitive data.

Memory Encryption (ME) technology, such as Total Memory Encryption (TME), provides one solution to protect data in memory. ME allows memory accesses by software executing on a processor core to be encrypted using an encryption key. For example, the encryption key may be a 128-bit key generated at a boot time and used to encrypt data sent over external memory buses. In particular, when the processor makes a write request to memory, the data may be encrypted by a memory encryption engine before being sent to memory, where it is stored in an encrypted form. When the data is read from memory, the data is sent to the processor in the encrypted form and is decrypted by the encryption key when received by the processor. Because data remains in the processor in the form of plaintext, the ME technology does not require modification to the existing software and how the existing software interacts with the processor.

A multi-key ME (MK-ME) technology is an extension of ME technology that provides support for multiple encryption keys. This allows for compartmentalized memory encryption. For example, the processor architecture may allow multiple encryption keys to be generated during the boot process (i.e., the operations performed by a computing system when the system is first powered on), which are to be used to encrypt different memory pages. Key identifiers (IDs) associated with the encryption keys may be used by various hardware and software components as part of the ME and MK-ME technologies. The multi-key extension is particularly suited to work with multi-domain architectures, such as architectures used by CSPs because the number of supported keys may be implementation dependent.

In some implementations, pages of a VM are designated to be encrypted using a VM-specific key. In other instances, some VM pages may remain in plaintext or may be encrypted using different ephemeral keys that may be opaque to software. A MK-ME engine may be used to support different pages to be encrypted using different keys. The MK-ME engine may support at least one key per domain and therefore achieve cryptographic isolation between different workloads.

In implementations of this disclosure, a TD architecture and instruction set architecture (ISA) extensions, referred to herein as TD extensions or TDX, is provided. TDX allows for multiple secure TDs corresponding to different client machines (e.g., VMs), guest operating systems, host operating systems, hypervisors, or the like. Additionally, different applications executed by the same client within the same guest OS may be executed securely using multiple TDs. Each TD may use one or more private keys that are not available to software executing outside the TD. In some embodiments, software executing in one TD may have access to private keys specific to that particular domain and to shared keys that may be used by multiple TDs. For example, a software running inside a TD may use a private key for its secure execution (e.g., read, write, execute operations), and the same software may use a shared key to access structures or devices shared with other TDs (e.g., printers, keyboard, mouse, monitor, network adapter, router, etc.).

A TD may be secured even from privileged users, such as the OS (either host or guest), VMM, basic input/output system (BIOS) firmware, system management mode, and the like. If malicious software takes over a privileged domain, such as the OS, sensitive data stored in memory by the TD will remain protected.

Each TD may operate independently of other TDs and use logical processor(s), memory, and I/O assigned by a trust domain resource manager (TDRM). The TDRM may operate as part of the host OS, the hypervisor, or as a separate software program, and has full control of the cores and other platform hardware. The TDRM assigns logical processors (e.g., execution threads of a physical processor) to TDs; however, the TDRM in some implementations may not access the TD's execution state on the assigned logical processor(s). Similarly, a TDRM may assign physical memory and I/O resources to the TDs, but may not be privy to access the memory state of a TD due to the use of separate encryption keys. Software executing in a TD may operate with reduced privileges (e.g., tenant software may not have full access to all resources available on the host system) so that the TDRM can retain control of platform resources. However, the TDRM cannot affect the confidentiality or integrity of the TD state in memory or in the CPU structures under defined circumstances.

TDX may operate concurrently with other virtualization architecture extensions, such as VMX, which allows multiple operating systems to simultaneously share processor resources in a safe and efficient manner. A computing system with VMX may function as multiple virtual systems or VMs. Each VM may run OSes and applications in separate partitions. VMX also provides a layer of system software called the virtual machine monitor (VMM), used to manage the operation of virtual machines.

VMX may provide a virtual machine control structure (VMCS) to manage VM transitions (e.g., VM entries and VM exits). A VM entry is a transition from VMM into VM operation. VM entries may be triggered by an instruction executed by the VMM. A VM exit is a transition from VM operation to the VMM. VM exits may be triggered by events such as exceptions requiring an exit from the VM. For example, a page fault in a page table supporting the VM may cause a VM exit. The VMCS may be a 6-part data structure to manage these VM transitions. The VMCS may keep track of: a guest state area (e.g., the processor state when a VM exit occurs, which is loaded on VM entries); a host state area (e.g., the processor state that is loaded on VM exits); VM-execution control fields (e.g., fields that determine the causes of VM exits); VM-exit control fields; VM-entry control fields; and VM-exit information fields (e.g., files that receive information on VM exits and describe the cause and nature of the VM exit).

In some implementations, TDX may operate as a substitute for VMX, which includes many of the features of VMX and adds an additional layer of security, in accordance with embodiments described herein. In other implementations, TDX may operate concurrently with VMX. For example, a host server running virtualization architecture (e.g., VMX) may need to utilize both MK-ME technology and TDX architecture for efficient execution of tenant software. A host server may execute highly sensitive applications within TDs so that the hypervisor executing VMs does not have access to the memory pages and encryption keys allocated to a TD and its trusted computing base (TCB). A TCB refers to a set of hardware, firmware, and/or software components that have an ability to influence the trust for the overall operation of the system. At the same time, the host server may run applications that demand less security and isolation using MK-ME technology where the hypervisor retains control over memory pages and encryption keys used in these less sensitive applications. The VMM may then isolate different applications from each other using different MK-ME keys, but still remain in the TCB of each application.

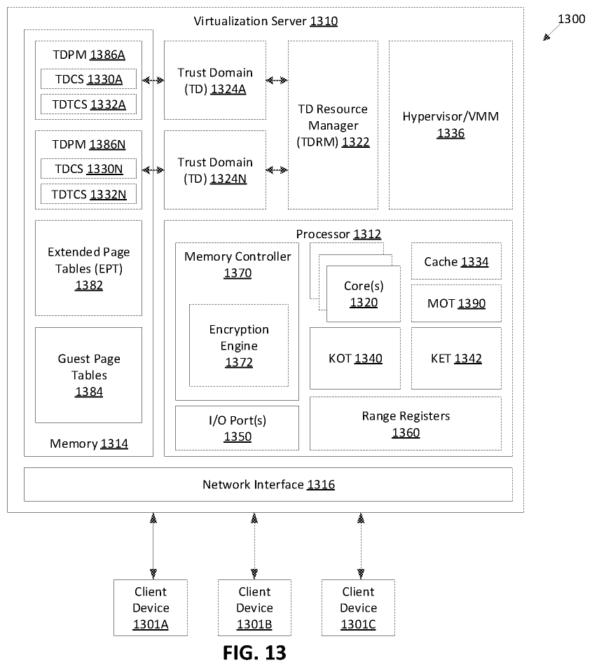

FIG. 13 illustrates a schematic block diagram of a computing system 1300 providing isolation in virtualized systems using TDs, according to implementations of this disclosure. Computing system 1300 may include a virtualization server 1310 that includes a processor 1312, a memory 1314, and a network interface 1316. Processor 1312 may implement TD architecture and ISA extensions for the TD architecture (e.g., TDX).

TD 1324A, 1324N may be executed as part of the TD architecture implemented by processor 1312. TD 1324A, 1324N may refer to a software execution environment to support a customer (e.g., tenant) workload. The tenant workload may include an OS, along with other applications running on top of the OS. The tenant workload may also include a VM running on top of a VMM. The TD architecture may provide a capability to protect the tenant workload running in a TD 1324A, 1324N by providing isolation between TD 1324A, 1324N and other software (e.g., CSP-provided software) executing on processor 1312. The TD architecture does not impose any architectural restrictions on the number of TDs operating within a system, however, software and hardware limitations may limit the number of TDs running concurrently on a system due to other constraints.

A tenant workload may be executed within a TD 1324A, 1324N when the tenant does not trust a CSP to enforce confidentiality. In order to operate in accordance with implementations of this disclosure, a CPU on which the TD is to be executed must support the TD architecture. In one embodiment, the tenant workload may include a VM running on top of a VMM. As such, a virtualization mode (e.g., VMX) may also be supported by the CPU on which the TD is to be executed. In another embodiment, TD 1324A, 1324N may not operate using a virtualization mode, but instead may run an enlightened operating system (OS) within TD 1324A, 1324N.

The TD architecture may provide isolation between TD 1324A, 1324N and other software executing on processor 1312 through functions including memory encryption, TD resource management, and execution state and management isolation capabilities. Memory encryption may be provided by an encryption circuit of processor 1312 (e.g., encryption engine 1372). In embodiments of this disclosure, encryption engine 1372 may be a multi-key total memory encryption (MK-ME) engine. Total Memory Encryption (ME) technology allows memory accesses by software executing on a processor core to be encrypted using an encryption key. Multi-key ME technology may be an extension of ME that provides support for multiple encryption keys, thus allowing for compartmentalized encryption. Memory encryption may be further supported by several key tables maintained by processor 1312 (e.g., key ownership table (KOT) 1340 and key encryption table (KET) 1342). The key tables may be stored in on-chip memory, where the on-chip memory is not directly accessible by software executed by the processing device. The on-chip memory may be physically located on the same chip as the processing core. Resource management capability may be provided by a TDRM 1322. Execution state and management capabilities may be provided by a memory ownership table (MOT) 1390 and access-controlled TD control structures, such as a trust domain control structure (TDCS) 1330A, 1330N and a trust domain thread control structure (TDTCS) 1332A, 1332N.

TDRM 1322 represents a resource management layer of the TD architecture. In some embodiments, TDRM 1322 may be implemented as part of the CSP/root VMM (e.g., a primary VMM that manages machine level operations of VMM and VMs). TDRM 1322 may be a software module included as part of the TD architecture that manages the operation of TDs 1324A, 1324 N. TDRM 1322 may act as a host and have control of the processor and other platform hardware. TDRM 1322 may assign software in a TD with logical processor(s) and may also assign physical memory and I/O resources to a TD. While TDRM 1322 may assign and manage resources, such as CPU time, memory, and I/O access to TDs 1324A, 1324N, TDRM 1322 may operate outside of the TCB of TDs 1324A, 1324N. For example, TDRM may not access a TD's execution state on the assigned logical processor(s) and may not be privy to access/spoof the memory state of a TD. This may be enforced by the use of separate encryption keys and other integrity/replay controls on memory.

Virtualization server 1310 may support a number of client devices 1301A-1301C. TDs may be accessible by client devices 1301A-1301C via network interface 1316. Client devices 1301A-1301C may communicate with each other, and with other devices, via software executing on processor 1312 (e.g., CSP-provided software). TD 1324A, 1324N may refer to a tenant workload that client devices 1301A-1301C execute via processor 1312. As discussed previously, the tenant workload may include an OS as well as ring-3 applications running on top of the OS. The tenant workload may also include a VM running on top of a VMM (e.g., hypervisor) along with other ring-3 applications, in accordance with embodiments described herein. Each client device 1301A-1301C may include, but is not limited to, a desktop computer, a tablet computer, a laptop computer, a netbook, a netbook computer, a personal digital assistant (PDA), a server, a workstation, a cellular telephone, a mobile computing device, a smart phone, an Internet appliance or any other type of computing device.

Processor 1312 may include one or more cores 1320 (also referred to herein as processing cores 1320), range registers 1360, a memory controller 1370 (e.g., a memory management unit (MMU)), and I/O ports 1350. Processor 1312 may be used in a computing system 1300 that includes, but is not limited to, a desktop computer, a tablet computer, a laptop computer, a netbook, a notebook computer, a PDA, a server, a workstation, a cellular telephone, a mobile computing device, a smart phone, an Internet appliance or any other type of computing device. In another embodiment, processor 1312 may be used in a system-on-a-chip (SoC) system.

One or more logical processors (e.g., execution threads) may operate on processing cores 1320. TD 1324A, 1324N may operate on these execution threads. TDRM 1322 may act as a full host and have full control over processing cores 1320 and all logical processors operating on processing cores 1320. TDRM 1322 may assign software within TD 1324A, 1324N to execute on the logical processor associated with TD 1324A, TD 1324N. However, in embodiments of this disclosure, TDRM 1322 may not access the execution state of TD 1324A, 1324N on the assigned logical processor(s) by the use of separate encryption keys. TDRM 1322 may be prevented from accessing the execution state of TD 1324A, 1324N because it is outside of the TCB of TD 1324A, 1324N. Therefore, TDRM 1322 may not be trusted to access the execution state, which could potentially provide information about the tenant workload to untrusted TDRM 1322. Preventing TDRM 1322 from accessing the execution state of TD 1324A, 1324N enforces integrity of the tenant workload executing on TD 1324A, 1324N.

Virtualization server 1310 may further include memory 1314 to store program binaries and other data. Memory 1314 may refer to main memory, or may refer to both main memory and secondary memory, which may include read-only memory (ROM), hard disk drives (HDD), etc. TDRM 1322 may allocate a specific portion of memory 1314 for use by TD 1324A, 1324N, as TDPM 1386A, 1386N. TDPM 1386A, 1386N may be encrypted by a one-time cryptographic key generated by TDRM 1322 when TD 1324A, 1324N is created. TDRM 1322 may generate the one-time cryptographic key to encrypt TDPM 1386A, 1386N, but may not use the one-time cryptographic key to access contents stored within TDRM 1386A, 1386N.

TD 1324A, 1324N may use virtual memory addresses that are mapped to guest physical memory addresses, and guest physical memory addresses that are mapped to host/system physical memory addresses by memory controller 1370. When TD 1324A, 1324N attempts to access a virtual memory address that corresponds to a physical memory address of a page loaded into memory 1314, memory controller 1370 may return the requested data through the use of an extended page table (EPT) 1382 and a guest page table (GPT) 1384. Memory controller 1370 may include EPT walk logic and GPT walk logic to translate guest physical addresses to host physical addresses of main memory, and provide parameters for a protocol that allows processing core(s) 1320 to read, walk, and interpret these mappings.

In one embodiment, tasks executed within TD 1324A, 1324N may not access memory 1314 directly using the physical address of memory 1314. Instead, these tasks access virtual memory of TD 1324A, 1324N through virtual addresses. The virtual addresses of virtual memory pages within the virtual memory may be mapped to the physical addresses of memory 1314. The virtual memory of TD 1324A, 1324N may be divided into fixed sized units called virtual memory pages that each has a corresponding virtual address. Memory 1314 may be organized according to physical memory pages (e.g., memory frames) that each have a fixed size. Each memory frame may be associated with an identifier that uniquely identifies the memory frame. A virtual memory page of the virtual address may be mapped corresponding to a fixed-sized unit in the physical address space of memory 1314 (e.g., a memory frame, a physical memory page). During execution of a guest application (e.g., a VM) within TD 1324A, 1324N, responsive to a request to access memory 1314, processor 1312 may use mappings (e.g., mappings of virtual memory page to physical memory page in page tables such as GPT 1384 of the guest application and EPT 1382 of TDRM 1322) to access physical memory pages of memory 1314.

In one embodiment, TD 1324A, 1324N may be created and launched by TDRM 1322. TDRM 1322 may create TD 1324A, for example, by executing a specific instruction (e.g., TDCREATE). TDRM 1322 may select a 4 KB aligned region of physical memory 1314 (corresponding to one memory page) and provide the address of the memory page as a parameter to the instruction to create TD 1324A. The instruction executed by TDRM 1322 may further cause processor 1312 to generate a one-time cryptographic key (also referred to as an ephemeral key). The one-time cryptographic key may be assigned to an available HKID stored in KOT 1340. KOT 1340 may be a data structure, invisible to software operating on processor 1312, for managing an inventory of HKIDs within the TD architecture. The available HKID may also be stored in TDCS 1330A. Processor 1312 may consult with MOT 1390 to allocate memory pages to TD 1324A. MOT 1390 may be a data structure, invisible to software operating on processor 1312, used by processor 1312 to enforce the assignment of physical memory pages to executing TDs. MOT 1390 may allow TDRM 1322 the ability to manage memory as a resource for each TD created (e.g., TD 1324A, 1324N), without having any visibility into data stored in the assigned TDPM.

Processor 1312 may utilize a memory encryption engine 1372 (e.g., MK-ME engine) to encrypt (and decrypt) memory accessed during execution of a guest process (e.g., an application or a VM) within TD 1324A, 1324N. As discussed above, ME allows memory accesses by software executing on a processing core (e.g., processing core(s) 1320) to be encrypted using an encryption key. MK-ME is an enhancement to ME that allows the use of multiple encryption keys, thus allowing for compartmentalized encryption. In some embodiments, processor 1312 may utilize encryption engine 1372 to cause different pages to be encrypted using different encryption keys (e.g., one-time encryption keys). In various embodiments, encryption engine 1372 may be utilized in the TD architecture described herein to support one or more encryption keys (e.g., ephemeral keys) generated for each TD 1324A, 1324N to help achieve cryptographic isolation between different tenant workloads. For example, when encryption engine 1372 is used in the TD architecture, the CPU may enforce by default that all pages associated with each TD 1324A, 1324N are to be encrypted using a key specific to that TD.

Each TD 1324A-1324N may further choose specific TD pages to be plain text or encrypted using different encryption keys that are opaque to software executing on processor 1312 (e.g., CSP-provided software). For example, memory pages within TDPM 1386A, 1386N may be encrypted using a combination of encryption keys which are unknown to TDRM 1322, and a binding operation (e.g., an operation to map the TD's virtual addresses to corresponding physical addresses). The binding operation, executed by TDRM 1322, may bind the memory pages within TDPM 1386A, 1386N to a particular TD by using a host physical address (HPA) of the page as a parameter to an encryption algorithm, that is utilized to encrypt the memory page. Therefore, if any memory page is moved to another location of memory 1314, the memory page cannot be decrypted correctly even if the TD-specific encryption key is used.

In one embodiment, TD 1324A, 1324N may be destroyed by TDRM 1322. TDRM 1322 may cause TD 1324A, for example, to stop executing on a logical processor associated with TD 1324A by executing a specific instruction (e.g., TDSTOP). TDRM 1322 may flush all cache entries of a cache 1334, wherein cache 1334 is associated with the logical processor executing TD 1324A. One all cache entries of cache 1334 have been flushed, TDRM 1322 may mark the HKID assigned to the one-time cryptographic key as available for assignment to other one-time cryptographic keys associated with other TDs (e.g., TD 1324N). The TDRM 1322 may then remove all pages from TDPM associated with TD 1324A (e.g., TDPM 1386A).

B. Embodiments for Implementing Shared Virtual Memory (SVM) in Trust Domains

Memory associated with a trust domain (TD) can be grouped into two categories: private memory and shared memory. In one embodiment, a multi-key total memory encryption (MK-TME) engine applies memory encryption for both private memory and shared memory using different keys.

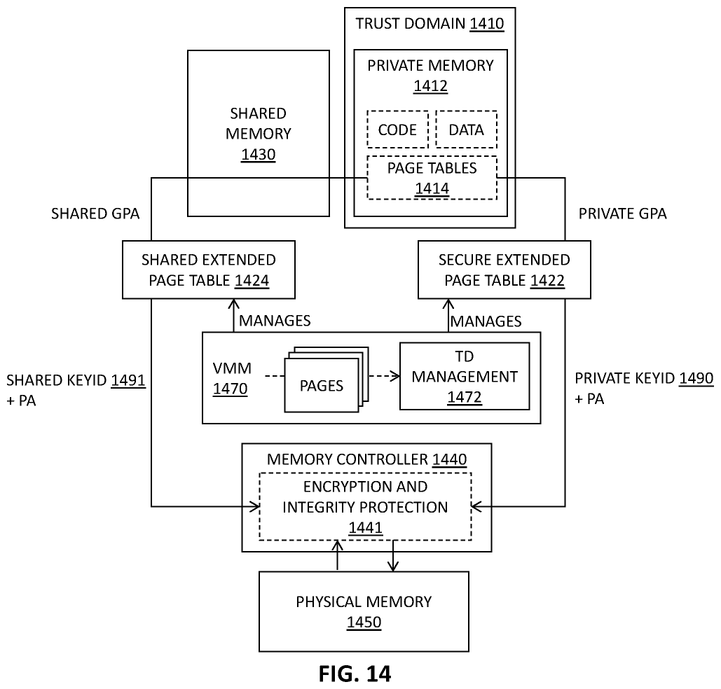

FIG. 14 illustrates one such implementation where an encryption and integrity protection engine 1441 of a memory controller 1440 performs encryption for shared and private regions in physical memory 1450 using different KeyIDs. For example, a private memory space 1412 associated with a TD 1410 is encrypted using a private KeyID 1490 (associated with a TD private key) and a shared memory space 1430 using a shared KeyID 1491 (associated with a TD shared key). This arrangement ensures that the private memory region 1412 is only accessible from inside the TD 1410.

As illustrated, address translations for the private memory 1410 require a lookup in both a TD page table 1414 stored in the TD private memory 1414 and a secure extended page table (SEPT) 1422 managed by TD management extensions 1472 of a VMM 1470. Address translations for the shared memory 1430 require a lookup in the TD page table 1414 and a shared extended page table 1424, also managed by the VMM 1470.

The shared memory 1430 is used by the TD 1410 to exchange data with external entities and is accessible by entities across the platform including the VMM 1470, input/output memory management unit (IOMMU) and/or I/O devices (e.g., Peripheral Component Interconnect Express (PCIe) devices).

In one particular embodiment, the TD management engine 1472 implements the Intel® Trust Domain Extensions (TDX) including functions triggered by the SEAMCALL (TDH) and TDCALL (TDG) instructions. The SEAMCALL (TDH) instruction is used by the host VMM 1470 to invoke host-side TDX interface functions. Host-side interface function names start with TDH (Trust Domain Host). The TDCALL (TDG) instruction is used by the guest TD software in TDX non-root mode to invoke guest-side TDX functions. Guest-side interface function names start with TDG (Trust Domain Guest).

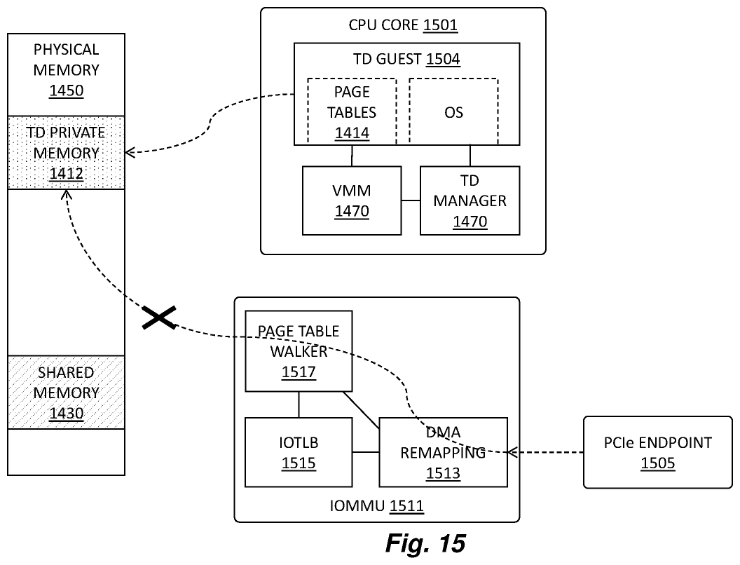

FIG. 15 illustrates a PCIe endpoint device 1505 coupled to an IOMMU 1511 with a DMA remapping engine 1513 for performing address remapping functions, an input/output translation lookaside buffer (TLB) for caching address translations, and a page table walker 1517 for performing page walk operations to populate the IOTLB 1515. A TD private memory region 1412 is shown within physical memory 1450 and is associated with a TD guest 1504 running on a CPU core 1501.

As indicated by the X, even though the IOMMU 1511 may support Shared Virtual Memory (SVM), SVM cannot be used within the trust domain. This is because for SVM functionality, the IOMMU 1511 must have access to the page tables 1414 within the TD 1504 for Guest Virtual Address (GVA) to Guest Physical Address (GPA) translations. However, this set of page tables 1414 belong to private memory 1412 that is not accessible to the IOMMU 1511. Therefore, while DMA can be used for shared memory regions 1430, the IOMMU cannot perform GVA-to-GPA translations as it does not have the necessary privilege to access the first-level page tables 1414 in the TD 1504.

The embodiments of the invention unblock these architectural restrictions, thereby allowing SVM to be used securely within TDs. While the embodiments described below sometimes focus on a TDX implementation, the underlying principles of the invention may be applied to any trust domain architecture with corresponding features.

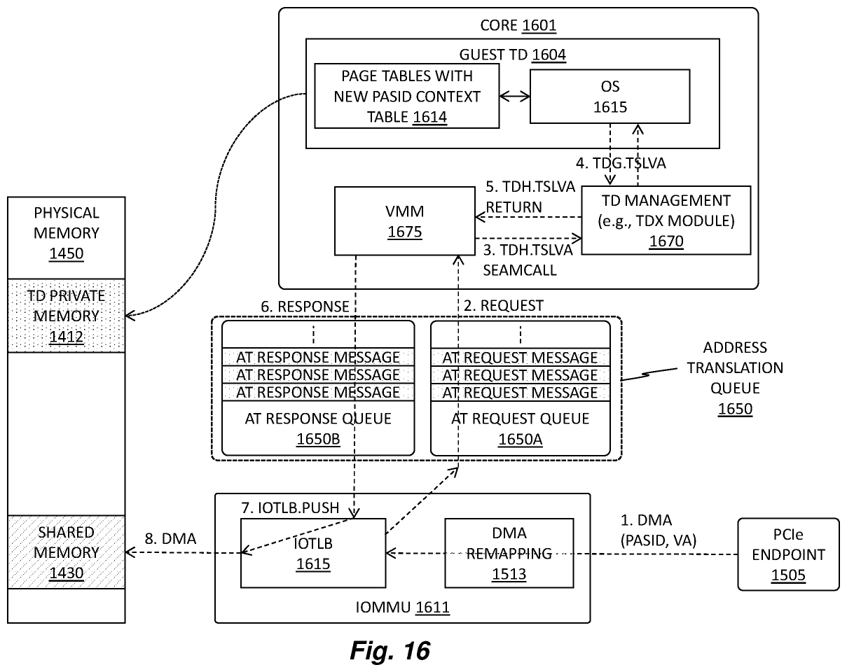

FIG. 16 illustrates an IOMMU 1611 and TD management logic 1670 of a core 1601 operable in accordance with one embodiment of the invention. In one implementation, the TD management logic 1670 comprises a TDX module to implement the techniques described herein within the context of TDX trusted domain extensions. For example, the TDX module of one embodiment is hosted in a reserved memory space identified by a set of secure arbitration mode range registers (SEAMRR). The processor only allows access to software executing from within the reserved memory space. However, the underlying principles of the invention may be implemented on other implementations in which regions of memory are encrypted and/or otherwise protected from unwanted access.

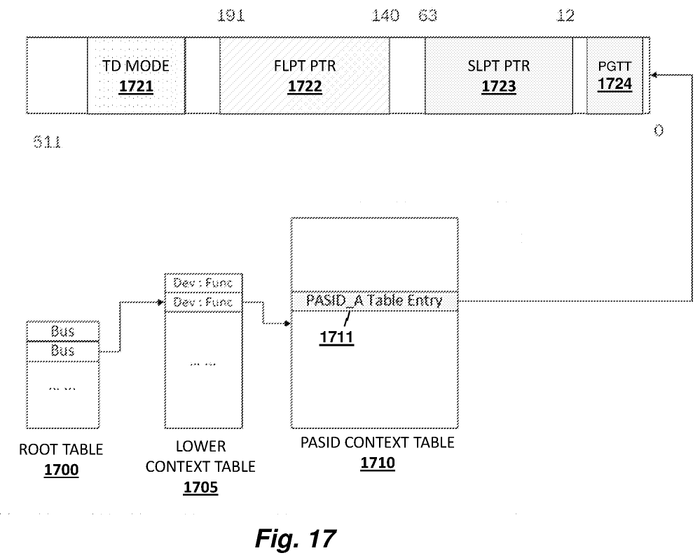

In the illustrated embodiment, a TD_MODE field is included in the PASID context tables associated with the TD guest 1604. FIG. 17 illustrates one embodiment of a 512-bit PASID table entry 1711 within a PASID table 1710 including the TD mode field 1721. Also shown is a first level page table pointer field 1722, a second level page table pointer field 1723, and a PASID granular translation type (PGTT) field 1724. The PASID table entry 1711 is pointed to by an entry (e.g., (Device:Function identifiers) in a lower context table 1705 which is identified by an entry in a root table 1700 (e.g., a Bus identifier).

In one embodiment, the IOMMU 1611 uses the TD mode field 1721 to determine whether a memory access request containing a virtual address from a PCIe device 1505 is associated with an application in a valid trust domain (e.g., such as TD guest 1604). If the TD mode field 1721 value indicates that the PASID is associated with an application in the TD 1604, the IOMMU 1611 uses a new control path (other than a first-level page table walk) to trigger the GVA→HPA translation process.

In addition, this embodiment includes a memory-backed queue pair referred as the Address Translation Queue (AT Queue) 1650 comprising an AT request queue 1650A and an AT response queue 1650B which are used for the IOMMU 1611 to communicate address translation requests to the VMM 1675. In one embodiment, the VMM 1675 programs new registers in the IOMMU 1611 with the physical addresses of the AT queue pair 1650A-B.

In one embodiment, a modified version of the host secure arbitration mode CALL function (SEAMCALL) is used, referred to herein as TDH.TSLVA. In the transaction sequence in FIG. 16, an instance of the TDH.TSLVA function is shown in transaction 3, with the corresponding return function shown as transaction 5 between the VMM 1675 and TDX module 1670. This function may be used by the VMM 1675 to inform the TDX module 1670 of each address translation request. The TDX module 1670 performs validation operations and, when a request is validated, the TD management module 1670 switches to non-root TDX mode which enters the guest-side TD 1604 (transaction 4).

A new TD guest 1604 TDCALL function is also provided, referred as TDG.TSLVA. This function is used by the guest TD OS 1615 to translate virtual addresses within an address space identified by the PASID, into physical addresses. Translated physical address are returned to the VMM 1675 as the result of the TDH.TSLVA function.

In one embodiment, the guest application binds a device 1505 to a PASID during initialization by calling the IOMMU API in the guest 1604. The VMM 1675 traps the emulated IOMMU operation and initializes the PASID context table 1710 on behalf of the guest 1604. The VMM 1675 sees the guest is a trusted domain 1604 and, as a result, the host IOMMU driver programs the TD_MODE field 1721 in the PASID context table entry 1711 to indicate this PASID works under TD mode. In one embodiment, the PASID granular translation type (PGTT) field 1724 in the PASID context table entry 1711 is set to nested translation mode, but the first level page table pointer (FLPT_PTR) 1722 is zeroed as it is not required for SVM. The IOMMU driver maps the PASID to a trusted domain identifier (TDID).

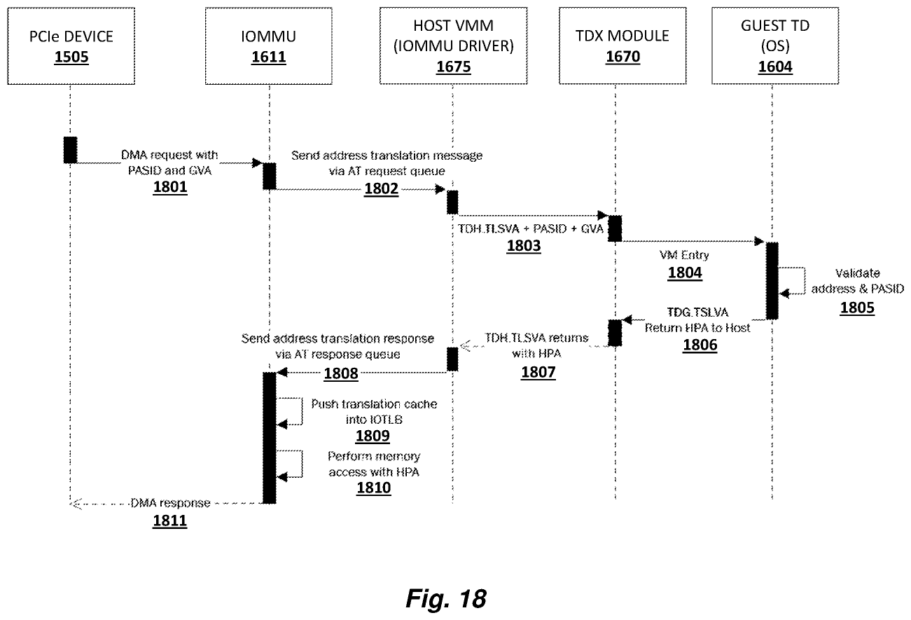

A details transaction sequence in accordance with one embodiment of the invention is illustrated in FIG. 18. This transaction process may be implemented within the context of the processor and system architectures described herein, but may also be implemented in a variety of other architectures.

Prior to the sequence of transactions, the guest application in the trust domain 1824 prepares memory for direct memory access operations, creating space in the shared memory region of the physical memory accordingly and populating page tables in the trust domain for guest virtual to guest physical address translations (GVA→GPA) and shared extended page tables for guest physical to host physical address translations (GPA→HPA).

At 1801, the PCIe device 1505 affiliated with the trust domain sends a DMA request containing the PASID and the guest virtual address (GVA). The IOMMU 1611 determines that the IOTLB 1615 does not include an entry to match this DMA request and therefore must perform an address translation operation.

At 1802, the IOMMU 1611 uses the PASID to locate the corresponding PASID context table entry. From the PASID context table entry, the IOMMU 1611 determines that this PASID is working in trust domain mode (e.g., based on the TD mode field 1721). Instead of traversing page tables, the IOMMU 1611 transmits an address translation request to the IOMMU driver in the VMM 1675 through the AT request queue 1650, providing both the PASID and the GVA, while sending an interrupt to the host IOMMU software.

The IOMMU driver in the VMM 1675 receives the translation request from the AT request queue 1650 and extracts the PASID and GVA to be translated. It locates the corresponding TD from the PASID-to-TDID mapping, then invokes the TDH.TSLVA command (e.g., SEAMCALL+TDH.TSLVA+PASID+GVA) via a transaction 1803 with the TDX module 1670.

The TDX module 1670 validates the command and switches to TDX non-root mode (guest mode), executing a VM entry 1804 to notify the OS within the guest TD 1604 of the translation request. The OS in the guest TD 1604, upon receiving the translation request, at 1805 verifies the address and performs permission checks to determine whether the address translation can be performed. If the address is within a valid range and other permissions indicate the operation can proceed, the OS of the guest TD 1604 executes the TDG.TSLVA function at 1806 (e.g., TDCALL+TDG.TSLVA+GVA+PGD) so that the GVA-to-HPA translation is performed via the existing processor TLB or a nested page table walk within the TD, and directly returns to VMX root mode with the translated HPA. In one embodiment, the OS in the guest TD 1604 is responsible for locating the page global directory of the process/PASID which is the entry of the first level page table (mm_struct.pgd) using the PASID. In this embodiment, the translated HPA is not made visible to the OS.

At 1806, the TDX module 1670 receives the translated HPA and passes the HPA to the VMM 1675 at 1807 via a return code of the TDH.TSLVA function. Any translation error on the guest side can also be captured from the SEAMCALL instruction return code.

At 1808, the host IOMMU driver in the VMM 1675 transmits the translation result back to the IOMMU 1611 through the AT response queue 1650B. If the translation is successful, the IOMMU 1611 pushes the translation cache into the IOTLB 1615 at 1809. The same cache entry is reusable in subsequent DMA operations targeting the same buffer until the memory/cache is invalidated.

At 1810, the IOMMU performs a memory access (e.g., issues read/write) to the shared memory using the translated HPA and the DMA response is returned to the PCIe device at 1811.

From a security perspective, the VMM 1675 and IOMMU 1611 are only responsible for dispatching the translation request to the trust domain 1604 but cannot access TD private memory directly. The final translation is handled inside the TD 1604 with a validity check on the virtual address prior to the translation. Furthermore, the VMM 1675 dispatches translation requests to the TD 1604 through the secure SEAMCALL interface and TDX module 1670. Therefore, malicious attacks from devices 1505 or the VMM 1675 can be blocked.

The above-described embodiments of the invention provide a solution to the limitations associated with current IOMMU operation in trust domain environments. Shared virtual memory (SVM) is an important IOMMU feature to increase 10 performance (e.g. by zero-copy in application, and address translation offloading) as well as ease of use and can now be used in combination with trust domains.

In the foregoing specification, the embodiments of invention have been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

### EXAMPLES

The following are example implementations of different embodiments of the invention.

Example 1. A processor comprising: a plurality of cores; a memory controller coupled to the plurality of cores to establish a first private memory region in a system memory using a first key associated with a first trust domain of a first guest; an input/output memory management unit (IOMMU) coupled to the memory controller, the IOMMU to receive a memory access request by an input/output (IO) device, the memory access request comprising a first address space identifier and a guest virtual address (GVA), the IOMMU to access an entry in a first translation table using at least the first address space identifier to determine that the memory access request is directed to the first private memory region which is not directly accessible to the IOMMU, the IOMMU to generate an address translation request associated with the memory access request, wherein based on the address translation request, a virtual machine monitor (VMM) running on one or more of the plurality of cores is to initiate a secure transaction sequence with trust domain manager to cause a secure entry into the first trust domain to translate the GVA to a physical address based on the address space identifier, the IOMMU to receive the physical address from the VMM and to use the physical address to perform the requested memory access on behalf of the IO device.

Example 2. The processor of example 1 wherein the IOMMU further comprises: an IO translation lookaside buffer (IOTLB) to store a mapping between the GVA and the physical address.

Example 3. The processor of example 1 wherein at least a first core of the plurality of cores comprises: one or more secure range registers to indicate a reserved memory space; wherein the first core is to execute the trust domain manager within the reserved memory space and to prevent access to the reserved memory space by any software executing outside of the reserved memory space.

Example 4. The processor of example 1 wherein the VMM is to initiate the secure transaction by causing at least a first core of the plurality of cores to execute a secure arbitration mode CALL instruction to invoke the trust domain manager to cause the secure entry into the first trust domain, the secure arbitration mode CALL instruction to indicate the address space identifier and the GVA.

Example 5. The processor of example 4 wherein the trust domain manager is to validate the secure arbitration mode CALL instruction prior to causing the secure entry into the first trust domain, the secure entry comprising guest-mode execution of instructions within a first guest of the first trust domain.

Example 6. The processor of example 5 wherein the first guest is to determine the physical address based on the GVA by either locating an entry within a translation lookaside buffer (TLB) of the first core or by performance of a nested page table walk within the first trust domain.

Example 7. The processor of example 6 wherein the first guest is to provide the physical address to the VMM via the trust domain manager.

Example 8. The processor of example 7 wherein the IOMMU is to store the address translation request in an address translation queue, and wherein an IOMMU host driver in the VMM is to read the address translation request from the address translation queue and provide an address translation response comprising the physical address in an address translation response queue to be accessed by the IOMMU.

Example 9. The processor of example 6 wherein the physical address comprises a host physical address (HPA) and wherein the nested page table walk comprises a first stage lookup to determine a guest physical address (GPA) from the guest virtual address and a second stage lookup to determine the HPA from the GPA.

Example 10. A method comprising: executing instructions by a plurality of cores, the plurality of cores to access a memory via a memory controller; establishing a first private memory region in the system memory using a first key associated with a first trust domain of a first guest; receiving, at an input/output memory management unit (IOMMU) coupled to the memory controller, a memory access request by an input/output (IO) device, the memory access request comprising a first address space identifier and a guest virtual address (GVA) accessing, by the IOMMU, an entry in a first translation table using at least the first address space identifier to determine that the memory access request is directed to the first private memory region which is not directly accessible to the IOMMU, generating, by the IOMMU, an address translation request associated with the memory access request, wherein based on the address translation request, a virtual machine monitor (VMM) running on one or more of the plurality of cores is to initiate a secure transaction sequence with trust domain manager to cause a secure entry into the first trust domain to translate the GVA to a physical address based on the address space identifier, receiving, by the IOMMU, the physical address from the VMM and using the physical address to perform the requested memory access on behalf of the IO device.

Example 11. The method of example 10 further comprising: storing a mapping between the GVA and the physical address in an IO translation lookaside buffer (IOTLB).

Example 12. The method of example 10 further comprising: indicating a reserved memory space in one or more secure range registers of at least a first core of the plurality of cores; executing, by the first core, the trust domain manager within the reserved memory space and preventing access to the reserved memory space by any software executing outside of the reserved memory space.

Example 13. The method of example 10 the secure transaction is initiated by causing at least a first core of the plurality of cores to execute a secure arbitration mode CALL instruction to invoke the trust domain manager to cause the secure entry into the first trust domain, the secure arbitration mode CALL instruction to indicate the address space identifier and the GVA.

Example 14. The method of example 13 further comprising: validating, by the trust domain manager, the secure arbitration mode CALL instruction prior to causing the secure entry into the first trust domain, the secure entry comprising guest-mode execution of instructions within a first guest of the first trust domain.

Example 15. The method of example 14 wherein the first guest is to determine the physical address based on the GVA by either locating an entry within a translation lookaside buffer (TLB) of the first core or by performance of a nested page table walk within the first trust domain.

Example 16. The method of example 15 wherein the first guest is to provide the physical address to the VMM via the trust domain manager.

Example 17. The method of example 16 wherein the IOMMU is to store the address translation request in an address translation queue, and wherein an IOMMU host driver in the VMM is to read the address translation request from the address translation queue and provide an address translation response comprising the physical address in an address translation response queue to be accessed by the IOMMU.

Example 18. The method of example 15 wherein the physical address comprises a host physical address (HPA) and wherein the nested page table walk comprises a first stage lookup to determine a guest physical address (GPA) from the guest virtual address and a second stage lookup to determine the HPA from the GPA.

Example 19. A machine-readable medium having program code executed thereon which, when executed by a machine, causes the machine to perform the operations of: establishing a first private memory region in the system memory using a first key associated with a first trust domain of a first guest; receiving, at an input/output memory management unit (IOMMU) coupled to the memory controller, a memory access request by an input/output (IO) device, the memory access request comprising a first address space identifier and a guest virtual address (GVA) accessing, by the IOMMU, an entry in a first translation table using at least the first address space identifier to determine that the memory access request is directed to the first private memory region which is not directly accessible to the IOMMU, generating, by the IOMMU, an address translation request associated with the memory access request, wherein based on the address translation request, a virtual machine monitor (VMM) running on one or more of the plurality of cores is to initiate a secure transaction sequence with trust domain manager to cause a secure entry into the first trust domain to translate the GVA to a physical address based on the address space identifier, receiving, by the IOMMU, the physical address from the VMM and using the physical address to perform the requested memory access on behalf of the IO device.

Example 20. The machine-readable medium of example 19 further comprising program code to cause the machine to perform the operations of: storing a mapping between the GVA and the physical address in an IO translation lookaside buffer (IOTLB).

Example 21. The machine-readable medium of example 19 further comprising program code to cause the machine to perform the operations of: indicating a reserved memory space in one or more secure range registers of at least a first core of the plurality of cores; executing, by the first core, the trust domain manager within the reserved memory space and preventing access to the reserved memory space by any software executing outside of the reserved memory space.

Example 22. The machine-readable medium of example 19 the secure transaction is initiated by causing at least a first core of the plurality of cores to execute a secure arbitration mode CALL instruction to invoke the trust domain manager to cause the secure entry into the first trust domain, the secure arbitration mode CALL instruction to indicate the address space identifier and the GVA.

Example 23. The machine-readable medium of example 22 further comprising program code to cause the machine to perform the operations of: validating, by the trust domain manager, the secure arbitration mode CALL instruction prior to causing the secure entry into the first trust domain, the secure entry comprising guest-mode execution of instructions within a first guest of the first trust domain.

Example 24. The machine-readable medium of example 23 wherein the first guest is to determine the physical address based on the GVA by either locating an entry within a translation lookaside buffer (TLB) of the first core or by performance of a nested page table walk within the first trust domain.

Example 25. The machine-readable medium of example 24 wherein the first guest is to provide the physical address to the VMM via the trust domain manager.

Example 26. The machine-readable medium of example 25 wherein the IOMMU is to store the address translation request in an address translation queue, and wherein an IOMMU host driver in the VMM is to read the address translation request from the address translation queue and provide an address translation response comprising the physical address in an address translation response queue to be accessed by the IOMMU.

Example 27. The machine-readable medium of example 24 wherein the physical address comprises a host physical address (HPA) and wherein the nested page table walk comprises a first stage lookup to determine a guest physical address (GPA) from the guest virtual address and a second stage lookup to determine the HPA from the GPA.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1.-27. (canceled)

28. A processor comprising:
a plurality of cores;
a memory controller coupled to the plurality of cores to establish a first private memory region in a system memory using a first key associated with a first trust domain of a first guest;
an input/output memory management unit (IOMMU) coupled to the memory controller, the IOMMU to receive a memory access request by an input/output (IO) device, the memory access request comprising a first address space identifier and a guest virtual address (GVA), the IOMMU to access an entry in a first translation table using at least the first address space identifier to determine that the memory access request is directed to the first private memory region which is not directly accessible to the IOMMU,
the IOMMU to generate an address translation request associated with the memory access request, wherein based on the address translation request, a virtual machine monitor (VMM) running on one or more of the plurality of cores is to initiate a secure transaction sequence with trust domain manager to cause a secure entry into the first trust domain to translate the GVA to a physical address based on the address space identifier,
the IOMMU to receive the physical address from the VMM and to use the physical address to perform the requested memory access on behalf of the IO device.

29. The processor of claim 28 wherein the IOMMU further comprises:
an IO translation lookaside buffer (IOTLB) to store a mapping between the GVA and the physical address.

30. The processor of claim 28 wherein at least a first core of the plurality of cores comprises:
one or more secure range registers to indicate a reserved memory space;
wherein the first core is to execute the trust domain manager within the reserved memory space and to prevent access to the reserved memory space by any software executing outside of the reserved memory space.

31. The processor of any of claim 28 to herein the VMM is to initiate the secure transaction by causing at least a first core of the plurality of cores to execute a secure arbitration mode CALL instruction to invoke the trust domain manager to cause the secure entry into the first trust domain, the secure arbitration mode CALL instruction to indicate the address space identifier and the GVA.

32. The processor of claim 31 wherein the trust domain manager is to validate the secure arbitration mode CALL instruction prior to causing the secure entry into the first trust domain, the secure entry comprising guest-mode execution of instructions within a first guest of the first trust domain.

33. The processor of claim 32 wherein the first guest is to determine the physical address based on the GVA by either locating an entry within a translation lookaside buffer (TLB) of the first core or by performance of a nested page table walk within the first trust domain.

34. The processor of claim 33 wherein the first guest is to provide the physical address to the VMM via the trust domain manager.

35. The processor of claim 34 wherein the IOMMU is to store the address translation request in an address translation queue, and wherein an IOMMU host driver in the VMM is to read the address translation request from the address translation queue and provide an address translation response comprising the physical address in an address translation response queue to be accessed by the IOMMU.

36. The processor of any of claim 33 wherein the physical address comprises a host physical address (HPA) and wherein the nested page table walk comprises a first stage lookup to determine a guest physical address (GPA) from the guest virtual address and a second stage lookup to determine the HPA from the GPA.

37. A method comprising:
executing instructions by a plurality of cores, the plurality of cores to access a memory via a memory controller;
establishing a first private memory region in the system memory using a first key associated with a first trust domain of a first guest;
receiving, at an input/output memory management unit (IOMMU) coupled to the memory controller, a memory access request by an input/output (IO) device, the memory access request comprising a first address space identifier and a guest virtual address (GVA)
accessing, by the IOMMU, an entry in a first translation table using at least the first address space identifier to determine that the memory access request is directed to the first private memory region which is not directly accessible to the IOMMU,
generating, by the IOMMU, an address translation request associated with the memory access request,
wherein based on the address translation request, a virtual machine monitor (VMM) running on one or more of the plurality of cores is to initiate a secure transaction sequence with trust domain manager to cause a secure entry into the first trust domain to translate the GVA to a physical address based on the address space identifier,
receiving, by the IOMMU, the physical address from the VMM and using the physical address to perform the requested memory access on behalf of the IO device.

38. The method of claim 10 further comprising:
storing a mapping between the GVA and the physical address in an IO translation lookaside buffer (IOTLB).

39. The method of claim 37 further comprising:
indicating a reserved memory space in one or more secure range registers of at least a first core of the plurality of cores;
executing, by the first core, the trust domain manager within the reserved memory space and preventing access to the reserved memory space by any software executing outside of the reserved memory space.

40. The method of any of claim 37 to the secure transaction is initiated by causing at least a first core of the plurality of cores to execute a secure arbitration mode CALL instruction to invoke the trust domain manager to cause the secure entry into the first trust domain, the secure arbitration mode CALL instruction to indicate the address space identifier and the GVA.

41. The method of claim 40 further comprising:
validating, by the trust domain manager, the secure arbitration mode CALL instruction prior to causing the secure entry into the first trust domain, the secure entry comprising guest-mode execution of instructions within a first guest of the first trust domain.

42. The method of claim 41 wherein the first guest is to determine the physical address based on the GVA by either locating an entry within a translation lookaside buffer (TLB) of the first core or by performance of a nested page table walk within the first trust domain.

43. The method of claim 42 wherein the first guest is to provide the physical address to the VMM via the trust domain manager.

44. The method of claim 43 wherein the IOMMU is to store the address translation request in an address translation queue, and wherein an IOMMU host driver in the VMM is to read the address translation request from the address translation queue and provide an address translation response comprising the physical address in an address translation response queue to be accessed by the IOMMU.

45. The method of any of claim 42 wherein the physical address comprises a host physical address (HPA) and wherein the nested page table walk comprises a first stage lookup to determine a guest physical address (GPA) from the guest virtual address and a second stage lookup to determine the HPA from the GPA.

46. A machine-readable medium having program code executed thereon which, when executed by a machine, causes the machine to perform the operations of:
establishing a first private memory region in the system memory using a first key associated with a first trust domain of a first guest;
receiving, at an input/output memory management unit (IOMMU) coupled to the memory controller, a memory access request by an input/output (IO) device, the memory access request comprising a first address space identifier and a guest virtual address (GVA)
accessing, by the IOMMU, an entry in a first translation table using at least the first address space identifier to determine that the memory access request is directed to the first private memory region which is not directly accessible to the IOMMU,
generating, by the IOMMU, an address translation request associated with the memory access request,
wherein based on the address translation request, a virtual machine monitor (VMM) running on one or more of the plurality of cores is to initiate a secure transaction sequence with trust domain manager to cause a secure entry into the first trust domain to translate the GVA to a physical address based on the address space identifier,
receiving, by the IOMMU, the physical address from the VMM and using the physical address to perform the requested memory access on behalf of the IO device.

47. The machine-readable medium of claim 46 further comprising program code to cause the machine to perform the operations of:
storing a mapping between the GVA and the physical address in an IO translation lookaside buffer (IOTLB).
